(19) United States
(12) Patent Application Publication
(10) Pub. No.: US 2002/0141095 A1
(43) Pub. Date: Oct. 3, 2002

(54) Wireless communication device

(75) Inventor: Chihoko Yahiro, Tokorozawa-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/067,937

(22) Filed: Feb. 8, 2002

(30) Foreign Application Priority Data
Mar. 30, 2001 (JP) 2001-101855

(51) Int. Cl. G11B 19/02

(52) U.S. Cl. 360/69

(57) ABSTRACT

This invention is directed to a wireless communication device which includes a wireless unit for making a wireless communication with another wireless communication device, data size detection means for detecting the data size of the communication made with the other wireless communication device by the wireless unit, calculation means for calculating a total communication data size from the data size detected by the data size detection means, determination means for determining if the total communication data size calculated by the calculation means has exceeded a predetermined use limit, and restriction means for, when the determination means determines that the total communication data size has exceeded the predetermined use limit, restricting the communication of the wireless unit.

### CROSS-REFERENCE TO RELATED APPLICATIONS

This application is based upon and claims the benefit of priority from the prior Japanese Patent Application No. 2001-101855, filed Mar. 30, 2001, the entire contents of which are incorporated herein by reference.

### BACKGROUND OF THE INVENTION

1. Field of the Invention

The present invention relates to a wireless communication device which is attached to an information processing apparatus such as a personal computer, portable telephone, or the like, and a wireless communication method in the wireless communication apparatus and, more particularly, to a wireless communication card attached to an information processing apparatus.

2. Description of the Related Art

In recent years, wireless communication cards which are attached to information processing apparatuses such as a personal computer, PDA (Personal Digital Assistant), and the like have been developed. Such wireless communication card is attached to an information processing apparatus, and has a wireless unit for receiving data from another wireless communication device and sending the received data to the information processing apparatus, and sending data from the information processing apparatus to another wireless communication device.

The wireless communication card has a memory for saving data received by the wireless unit from another wireless communication device, or data from the information processing apparatus to which the wireless communication card is attached.

However, when a conventional wireless communication card is used, communications can be made by the wireless unit without any restrictions, and data can be saved in the memory. When data recorded in the memory has exceeded the memory size, the user must determine if any more data can be saved.

Therefore, use of the wireless unit of the conventional wireless communication card cannot be restricted based on a predetermined condition.

On the other hand, as a method of restricting use of a communication terminal, various techniques have been disclosed. For example, Jpn. Pat. Appln. KOKAI Publication No. 2000-148861 discloses a terminal used in an accounting system.

This terminal has a point value as accounting point information, which is consumed as pay information is input (purchased). An actual accounting process is executed by an accounting center by sending the accounting point information to the accounting center (or purchasing another accounting point information) at a given timing.

When the point value as accounting point information becomes zero, use of the terminal is restricted.

However, the aforementioned accounting system does not restrict communications of the wireless unit of the wireless communication device such as a wireless communication card attached to an information processing apparatus. Hence, no means for restricting communications of the wireless unit of the wireless communication device attached to the information processing apparatus is available.

### BRIEF SUMMARY OF THE INVENTION

The present invention has been made in consideration of the above situation, and has as its object to provide a wireless communication device which can restrict wireless communication of a wireless communication device attached to an information processing apparatus by a predetermined condition, and a communication method in the wireless communication device.

Therefore, in order to achieve the above object, the invention of the present invention is a communication device comprising: a unit configured to make a communication with other communication device; means for detecting a data size of the communication made with the other communication device by the unit; means for calculating a total communication data size from the data size detected by the data size detection means; means for determining if the total communication data size calculated by the calculation means exceeds a predetermined use limit; and means for restricting the communication via the unit when the determination means determines that the total communication data size exceeds the predetermined use limit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 depicts a system that uses a wireless communication device according to an embodiment of the present invention;

FIG. 2 is a block diagram showing a memory built-in wireless communication device 20;

FIG. 3 is a flow chart for explaining the operation when use of a wireless unit 4 is restricted by the communication data size;

FIG. 4 is a flow chart for explaining the operation when use of a wireless unit 4 is restricted by the communication time;

FIG. 5 is a flow chart for explaining the operation when use of a wireless unit 4 is restricted by the memory size; and

FIG. 6 is a flow chart for explaining the operation when use restriction of a wireless unit 4 is canceled.

### DETAILED DESCRIPTION OF THE INVENTION

A wireless communication device according to an embodiment of the present invention will be described hereinafter with reference to the accompanying drawings.

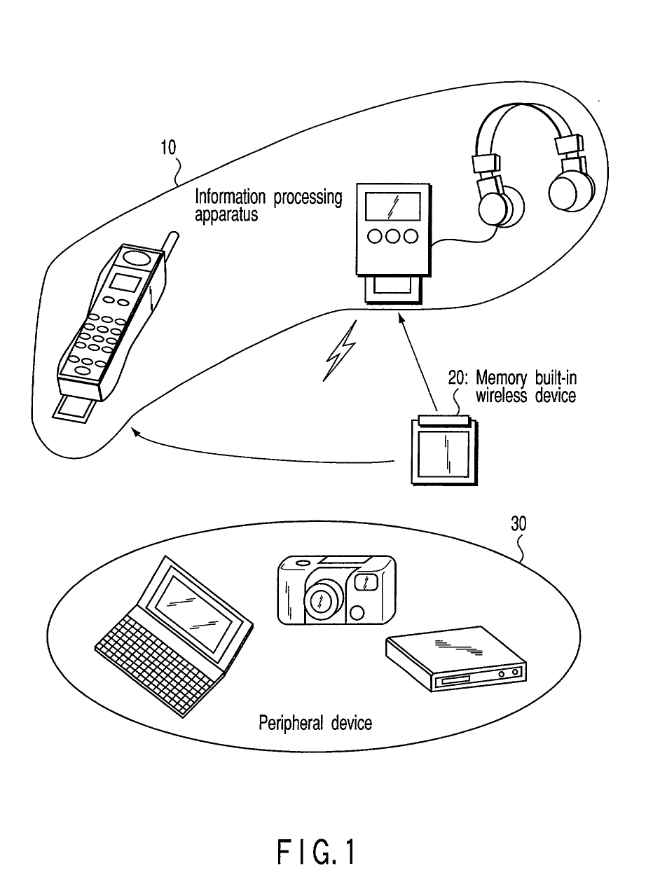

FIG. 1 shows a system that uses a wireless communication device according to an embodiment of the present invention.

As shown in FIG. 1, this system is constituted by various information processing apparatuses 10 such as a portable telephone, MP3 player, and the like, a memory built-in wireless device 20 as a characteristic feature of the present invention, and various peripheral devices 30 such as a personal computer, digital camera, and the like.

Each information processing apparatus 10 comprises a slot for detachably receiving the memory built-in wireless device 20. The memory built-in wireless device 20 inserted in this slot receives data transferred from various information processing apparatuses 10, and sends data to various peripheral devices 30. Also, the device 20 receives data sent from various peripheral devices 30, and sends the data to the information processing apparatus 10.

The memory built-in wireless device 20 has a card shape, and comprises a wireless communication function of exchanging data with various peripheral devices 30 via wireless communication channels. The wireless communication function uses, e.g., Bluetooth. Bluetooth is a near-distance wireless communication standard, which implements wireless communications within a 10 m or 100 m radius using the 2.4-GHz ISM (Industrial Science Medical) band.

On the other hand, each peripheral device 30 comprises a similar wireless communication function. That is, when the memory built-in wireless device 20 is attached to the information processing apparatus 10, the information processing apparatus 10 can exchange data with the peripheral devices 30 via wireless communications.

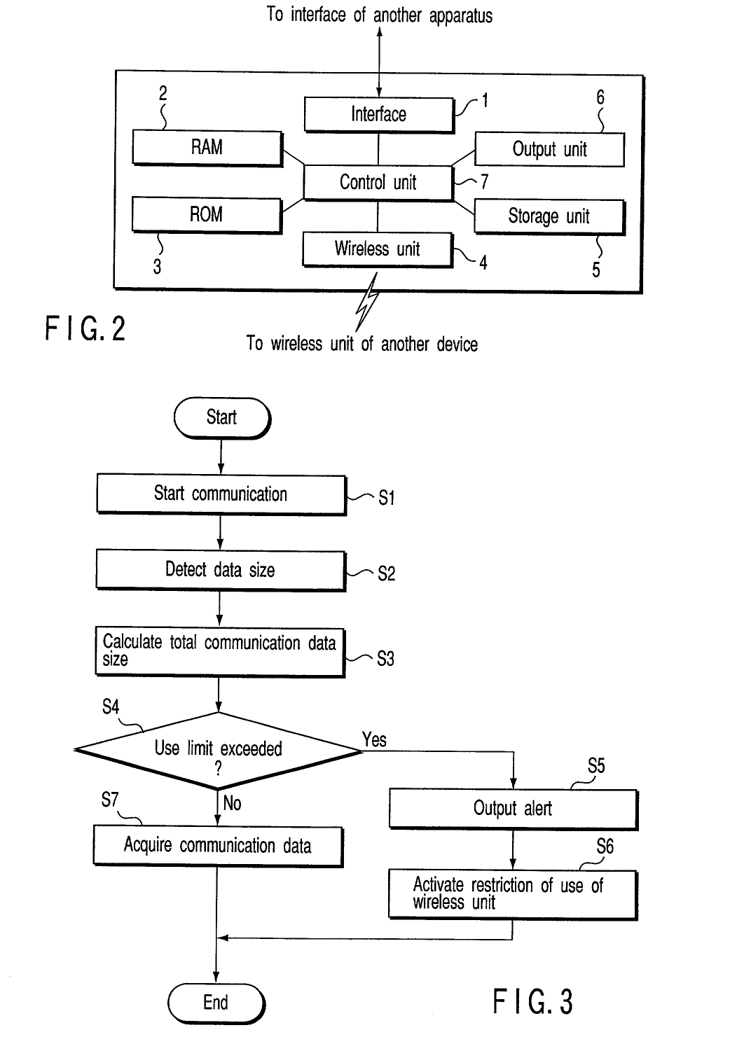

FIG. 2 shows the memory built-in wireless communication device 20.

As shown in FIG. 2, the memory built-in wireless device of this embodiment comprises an interface 1, RAM 2, ROM 3, wireless unit 4, storage unit 5, output unit 6, and control unit 7.

The interface 1 is used to connect another information processing apparatus, and data is exchanged with the information processing apparatus via the interface 1.

The RAM 2 temporarily stores information and data during execution of a program. The ROM 3 stores a program that implements the operation of the wireless communication device of this embodiment. The wireless unit 4 makes wireless communications with various peripheral devices.

The storage unit 5 stores data acquired via the interface 1 and wireless unit 4.

The output unit 6 comprises an LED, ON color of which changes when, for example, the control unit 7 restricts communications of the wireless unit 4.

The control unit 7 controls the overall wireless communication device. For example, the control unit 7 can compare the use limit with the total data size exchanged via communications or the use limit time and the total communication time, and can activate/cancel use restriction of the wireless unit 4.

In the wireless communication device of this embodiment, a position where the device of this embodiment is connected to each information processing apparatus is not particularly limited. Also, the device may be connected as either a built-in or independent device.

Furthermore, the method of transferring data to various information processing apparatuses via the interface 1, and the method of transferring information to various peripheral devices via the wireless unit 4 are not particularly limited.

The operation of the memory built-in wireless communication device according to the embodiment of the present invention will be described below.

### Restriction by Communication Data Size

A case will be explained with reference to the flow chart in FIG. 3 wherein use of the wireless unit 4 is restricted by the communication data size.

Assume that the use limit is 100 MB in this embodiment, and is stored in the RAM 2 or ROM 3.

If a communication of the wireless unit has started (S1), the size of communication data is detected (S2). The total of communication data is then calculated (S3).

In data communications of the wireless unit, the communication data size is calculated independently of transmission/reception. The total communication data size is calculated by accumulating the sizes of communication data detected in step S2.

It is checked if the total communication data size calculated in step S3 has exceeded the predetermined use limit (S4).

If it is determined in step S4 that the total communication data size has not exceeded the predetermined use limit, the communication data is acquired (S7), thus ending the processing. Note that the acquired communication data is stored in the storage unit 5.

On the other hand, if it is determined in step S4 that the total communication data size has exceeded the predetermined use limit, an alert is generated by the output unit 6 (S5) and the wireless unit 4 is disabled to inhibit wireless communications (S6), thus ending the processing. Note that the alert is generated by the output unit 6 by, e.g., changing the ON color of an LED from green to red. Note that the alert method may be implemented by sound or an alert message displayed on the information processing apparatus to which the wireless communication device is attached. That is, the alert method is not particularly limited.

Note that communications of the wireless unit 4 alone may be inhibited, and the wireless communication device may be used as a memory device that stores data from the information processing apparatus in the storage unit 5.

An example of the operation when use of the wireless unit is restricted by the communication data size will be explained below.

For example, assume that data A exchanged by the wireless unit 4 has a size of 15 MB. Also, assume that next exchanged data B has a size of 20 MB. Likewise, assume that data C has a size of 30 MB. In communications of these data, reception/transmission is not limited. The total of exchanged data A to C is 65 MB. Therefore, at this time, since the total size of communication data falls within the range of the use limit, a process for acquiring communication data is executed.

When the wireless unit 4 continues communications, the total of exchanged data exceeds 100 MB as the predetermined use limit. When the total size has exceeded 100 MB, an alert is generated, and wireless communications of the wireless unit 1 are inhibited from being used.

### Restriction by Communication Time

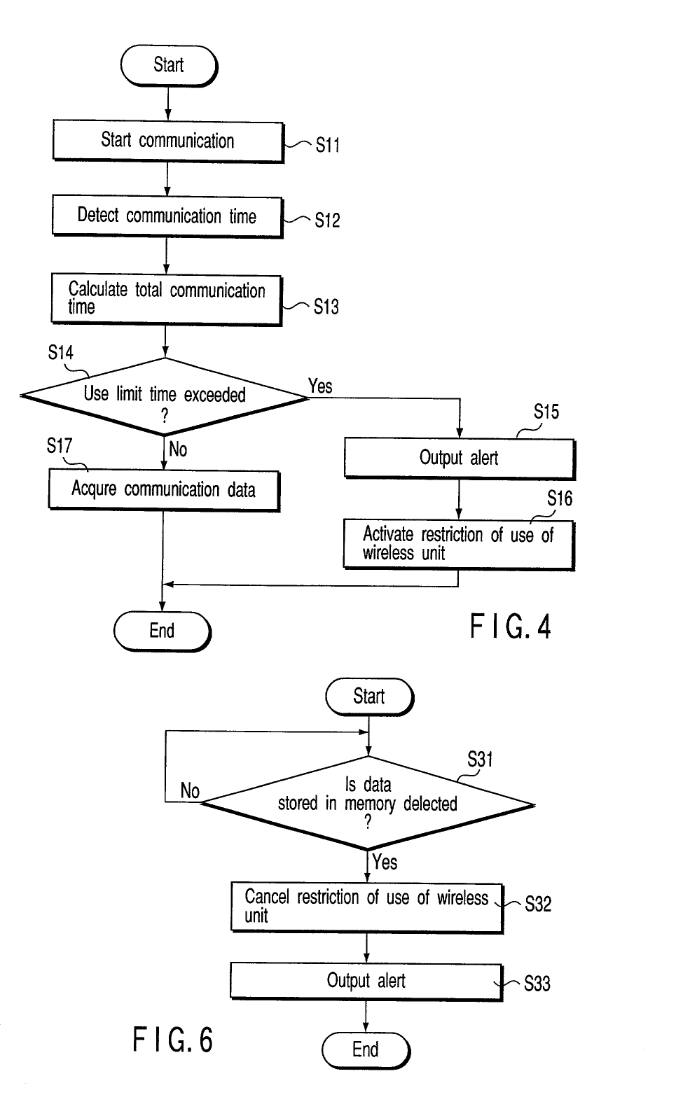

A case will be described below with reference to the flow chart in FIG. 4 wherein use of the wireless unit 4 is restricted by the communication time.

Assume that the use limit time is 100 hours in this embodiment, and is stored in the RAM 2 or ROM 3.

If a communication of the wireless unit has started (S11), a communication time is detected (S12). A total communication time is then calculated (S13).

In data communications of the wireless unit, the communication time is calculated independently of transmission/reception. The total communication time is calculated by accumulating the communication times detected in step S12.

It is then checked if the total communication time calculated in step S13 has exceeded the predetermined use limit time (S14).

If it is determined in step S14 that the total communication time has not exceeded the predetermined use limit time, the communication data is acquired (S17), thus ending the processing. Note that the acquired communication data is stored in the storage unit 5.

On the other hand, if it is determined in step S14 that the total communication time has exceeded the predetermined use limit time, an alert is generated by the output unit 6 (S15), and the wireless unit 4 is disabled to inhibit wireless communications (S16), thus ending the processing. Note that the alert is generated by the output unit 6 by, e.g., changing the ON color of an LED from green to red. Note that the alert method may be implemented by sound or an alert message displayed on the information processing apparatus to which the wireless communication device is attached. That is, the alert method is not particularly limited. Note that communications of the wireless unit 4 alone may be inhibited, and the wireless communication device may be used as a memory device that stores data from the information processing apparatus in the storage unit 5.

### Use Restriction by Memory Size

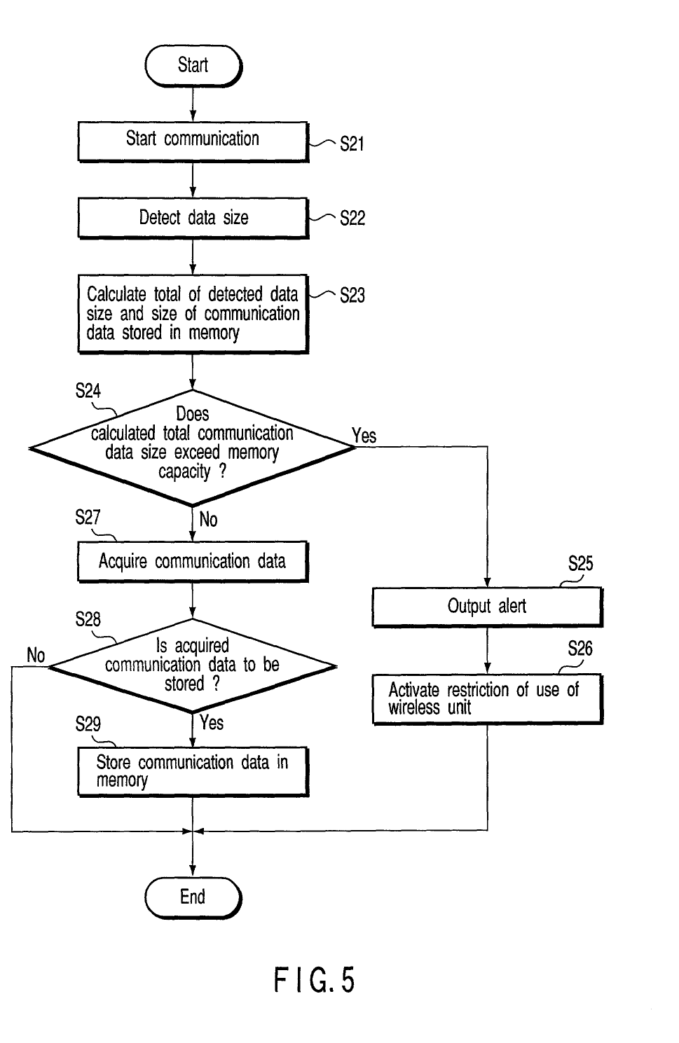

A case will be explained below with reference to the flow chart in FIG. 5 wherein use of the wireless unit is restricted by the memory size.

If a communication of the wireless unit has started (S21), the size of communication data is detected (S22). Then, the total of the detected communication data size and communication data size stored in the memory is then calculated (S23). In data communications of the wireless unit, the communication data size is calculated independently of transmission/reception.

It is checked if the calculated total communication data size has exceeded the memory size of the storage unit (memory) (S24). If it is determined in step S24 that the calculated total communication data size has not exceeded the memory size of the memory, the communication data is acquired (S27), and it is checked if the acquired communication data is to be saved (S28). Whether or not the communication data is to be saved may be determined according to a pre-set condition, or may be designated by the user from the information processing apparatus to which the wireless communication device is attached. That is, this method is not particularly limited.

If it is determined in step S28 that the communication data is to be saved, the acquired communication data is saved in the memory (S29), thus ending the processing. On the other hand, if it is determined in step S28 that the communication data is not to be saved, the processing ends.

On the other hand, if it is determined in step S24 that the total communication data size has exceeded the memory size of the memory, an alert is generated by the output unit 6 (S25), and the wireless unit 4 is disabled to inhibit wireless communications (S26), thus ending the processing. Note that the alert is generated by the output unit 6 by, e.g., changing the ON color of an LED from green to red. Note that the alert method may be implemented by sound or an alert message displayed on the information processing apparatus to which the wireless communication device is attached. That is, the alert method is not particularly limited. Note that communications of the wireless unit 4 alone may be inhibited, and the wireless communication device may be used as a memory device that stores data from the information processing apparatus in the storage unit 5.

When data saved in the storage unit (memory) is deleted (e.g., when data stored in the memory is transferred to another device or is deleted), communication restriction of the wireless unit is canceled.

FIG. 6 is a flow chart for explaining the operation for canceling use restriction of communications by the wireless unit. Note that a program for implementing this operation is executed when use of communications by the wireless unit in the wireless communication device is restricted.

As shown in FIG. 6, it is checked if data stored in the memory is deleted (S31). If it is determined in step S31 that data is deleted, use restriction of communications by the wireless unit is canceled (S32), and an alert is output (S33).

Note that the alert output in step S33 indicates that use restriction has been canceled, and its method is not particularly limited. For example, the ON color of the LED as the output unit of the wireless communication device may be changed from orange indicating use restriction to green indicating that use restriction has been canceled. Alternatively, a message indicating that use restriction of the wireless unit of the wireless communication device has been canceled may be displayed on the information processing apparatus to which the wireless communication device is attached.

An example of use restriction by the memory size will be explained below.

Assume that the storage unit of the wireless communication device has a memory size of 50 MB. Assume that data A saved in the storage unit (memory) has a size of 15 MB. Also, assume that next data B saved in the memory has a size of 20 MB. Likewise, assume that data C has a size of 15 MB.

The total of these data A, B, and C is 50 MB. If the size of data D is 10 MB, since the total data size exceeds the memory size of 50 MB as the use limit, use of the wireless unit is restricted. Note that use restriction means that wireless communications between the wireless unit of the wireless communication device and that of another wireless communication device can be made, but received data cannot be saved in the memory.

On the other hand, when data stored in the storage unit, e.g., data A, is deleted, use restriction of the wireless unit is canceled. At this time, an alert indicating that use restriction has been canceled is generated.

Therefore, according to the wireless communication device of this embodiment, when a predetermined condition is satisfied, since communications of the wireless unit can be restricted, use of the wireless communication device can be restricted.

In the above embodiment, communications of the wireless communication device are restricted by the communication time or communication data size, but the present invention is not limited to them.

Note that the present invention is not limited to the aforementioned embodiments, and various modifications may be made without departing from the scope of the invention when it is practiced. The respective embodiments may be combined as needed as long as possible, and combined effects can be obtained in such case. Furthermore, the embodiments include inventions of various stages, and various inventions can be extracted by appropriately combining a plurality of required constituent elements disclosed in this application. For example, even when some required constituent elements are deleted from all the required constituent elements disclosed in the embodiments, the deleted elements are compensated for as needed by known techniques when the extracted invention is practiced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication device comprising:
a unit configured to make a communication with other communication device;
means for detecting a data size of the communication made with the other communication device by said unit;
means for calculating a total communication data size from the data size detected by said data size detection means;
means for determining if the total communication data size calculated by said calculation means exceeds a predetermined use limit; and
means for restricting the communication via said unit when said determination means determines that the total communication data size exceeds the predetermined use limit.

2. A device according to claim 1, wherein the communication with the other communication device is performed by using a radio.

3. A device according to claim 1, wherein said communication device is detachable from the information processing apparatus.

4. A device according to claim 1, wherein said communication device is a communication card.

5. A device according to claim 1, further comprising an interface for making a data communication with the information processing apparatus, and
wherein said unit sends data sent from the information processing apparatus to the other communication device, and sends data received from another communication device to the information processing apparatus.

6. A device according to claim 1, further comprising means for generating an alert indicating that the communication of said unit is restricted when the communication of said unit is restricted by said restriction means.

7. A communication device comprising:
a unit configured to make a communication with other communication device;
means for detecting a communication time of the communication made with the other communication device by said unit;
means for calculating a total communication time from the communication time detected by said communication time detection means;
means for determining if the total communication time calculated by said calculation means exceeds a predetermined communication time; and
means for restricting the communication of said unit when said determination means determines that the total communication time exceeds the predetermined communication time.

8. A device according to claim 7, wherein said communication device is detachable from the information processing apparatus.

9. A device according to claim 7, wherein said communication device is a communication card.

10. A device according to claim 7, further comprising an interface for making a data communication with the information processing apparatus, and
wherein said unit sends data sent from the information processing apparatus to the other communication device, and sends data received from another communication device to the information processing apparatus.

11. A device according to claim 7, further comprising means for generating an alert indicating that the communication of said unit is restricted when the communication of said unit is restricted by said restriction means.

12. A communication device comprising:
a unit configured to make a communication with other communication device;
a memory storing communication data acquired by said unit;
means for detecting a data size of the communication made with the other communication device by said unit;
means for calculating a total size of the data size detected by said data size detection means, and communication data stored in said memory;
means for determining if the total communication data size calculated by said calculation means exceeds a memory size of said memory; and
means for restricting the communication of said unit when said determination means determines that the total communication data size exceeds the memory size of said memory.

13. A device according to claim 12, wherein said communication device is detachable from the information processing apparatus.

14. A device according to claim 12, wherein said communication device is a communication card.

15. A device according to claim 12, further comprising an interface for making a data communication with the information processing apparatus, and
wherein said unit sends data sent from the information processing apparatus to the other communication device, and sends data received from another communication device to the information processing apparatus.

16. A device according to claim 12, further comprising means for generating an alert indicating that the communication of said unit is restricted when the communication of said unit is restricted by said restriction means.

17. A device according to claim 12, further comprising means for canceling restriction of the communication of said unit when the communication of said unit is restricted by said restriction means and communication data stored in said memory is then deleted.

18. A communication method in a communication device which is attached to an information processing apparatus and comprises a unit that makes a communication with another communication device, comprising:
detecting a data size of the communication made with the other communication device by the unit;
calculating a total communication data size from the detected data size;
determining if the calculated total communication data size exceeds a predetermined use limit; and
restricting the communication of the unit when it is determined that the total communication data size exceeds the predetermined use limit.

19. A communication method in a communication device which is attached to an information processing apparatus and comprises a unit that makes a communication with another communication device, comprising:
detecting a communication time of the communication made with the other communication device by the unit;
calculating a total communication time from the detected communication time;
determining if the calculated total communication time exceeds a predetermined communication time; and
restricting the communication of the unit when it is determined that the total communication time exceeds the predetermined communication time.

20. A communication method in a communication device which is attached to an information processing apparatus and comprises a unit that makes a communication with another communication device, and a memory for storing communication data acquired by the unit, comprising:
detecting a data size of the communication made with the other communication device by the unit;
calculating a total size of the detected data size, and communication data stored in the memory;
determining if the calculated total communication data size exceeds a memory size of the memory; and
restricting the communication of the unit when it is determined that the total communication time exceeds the predetermined communication time.
